(19) United States
(12) Patent Application Publication
(10) Pub. No.: US 2020/0084974 A1
(43) Pub. Date: Mar. 19, 2020

(54) Original Single Blade Plant Pruner

(71) Applicant: Chad Eric Dorton, Acton, CA (US)

(72) Inventor: Chad Eric Dorton, Acton, CA (US)

(21) Appl. No.: 16/131,496

(22) Filed: Sep. 14, 2018

(51) Int. Cl. A01G 3/02

(52) U.S. Cl. CPC A01G 3/02

(57) ABSTRACT

The present invention, is a single blade clone cutter. The present inventions embodiment is in a u-shaped housing with a single removal blade. The blade locks in to the u-shaped housing to secure the blade from moving during the process of cutting. It is important to have a single blade that cuts onto a flat surface so there is no damage being done to the limb of the plant. It is a new invention because at this point to prune plants it is done with a scissor type cutter. The previous procedure to prune plants damages the limb of the plant.

### CROSS-REFERENCE TO RELATED APPLICATIONS

This application claims the benefit of provisional patent application Ser. No. 62/606,249, filed 2017 Sep. 15 by the present inventor.

### BACKGROUND-PRIOR ART

The following is a tabulation of some prior art that presently appears relevant:

### U.S. Patents

| Pat. No. | Issue Date | Patentee |
|---|---|---|
| 5,438,759 | 1995 Aug. 8 | Janice A. Dieringer |
| US D485,014 S | 2004 Jan. 6 | Dal LaMagna and |
| | | Mario Giampaoli |
| U.S. Pat. No. 8,984,754 B1 | 2015 Mar. 24 | Alexandre Rachid Kaidi |
| | | and Hamid Reza |
| | | Shamsapour |
| U.S. Pat. No. 8,429,825 B2 | 2013 Apr. 13 | James E. Johanson |
| 5,353,505 | 1994 Oct. 11 | Hidekazu Okada |
| 4,902,776 | 1978 Jun. 6 | William Ferguson |
| Des. 273,172 | 1984 Mar. 27 | Masami Yamagishi |
| US D613,571 S | 2010 Apr. 13 | Wolfram Quante |
| 5,016,353 | 1991 May 21 | Clemens A Iten |
| 4,053,979 | 1977 Oct. 18 | Harlan L. Tuthill and |
| | | John O. Freeborn |
| 5,711,075 | 1998 Jan. 27 | Jeffrey A. Wolf |
| U.S. Pat. No. 7,730,620 B1 | 2010 Jun. 8 | Christopher Anastasi |

### BACKGROUND

Plants are pruned today his using scissor type cutters. Today's plant pruners function with a scissor type, double blade cutting mechanism.

When pruning with scissor type cutters, the double blade cutting mechanism smashes the stem/cellular wall of the plant. When the cellular wall of a plant is damaged it takes longer or the new shoot or new node to grow.

Another problem with pruning a plant with double blade cutting mechanism is you have to sharpen the putter. Even having the sharpest scissor type cutter, you will still have damage to the cellular wall of the plant.

When using scissor type cutters, you must clean multiple blades to minimize the number of bacteria that is being transferred on to the plant limb.

### SUMMARY

Plant pruning is a very time consuming and tedious process which needs to remain sanitary, precise and safe throughout the process. The way plant pruning is done today is not the most effective or efficient process.

### DESCRIPTION OF THE PRIOR ART

U. S. Pat. No. 5,438,759 to Dieringer, is a Button Removal Device. Although the device has the u-shaped housing, it is used to remove buttons from card stock.

U.S. Pat. No. D485,014 S to LaMagna and Giampaoli, is a Cuticle Nipper Tweezer. The Tweezer has the u-shaped housing; however, it is designed to nip cuticles.

U.S. Pat. No. 8,984,754 B1 to Kaidi and Shamsapour, is a Nail Clipper with Blade Insert. The Nail Clipper has the u-shaped housing and removal blade, it is designed to cut finger or toe nails.

U.S. Pat. No. 8,429,825 B2 to Johanson, is a Cutting Apparatus. The Cutting Apparatus has the u-shaped housing with a slot for the blade to push through to an activated position, with the cutting edge extending outwardly of the slot and guide. The Apparatus is used to cut various materials such as paperboard or corrugated paper.

U.S. Pat. No. 5,353,505 to Okada, is Grip Scissors. The Scissors have the u-shaped housing with two blades that slide past each other. The Grip Scissors are used for thread-cutting.

U.S. Pat. No. 4,092,776 to Ferguson, is a Cutting Tool. The Cutting Tool has the u-shaped housing with two blades which are able to crossover and dear said cutting surface.

U.S. Pat. No. Des. 273,172 to Yamagishi, is a Thread Nipper or The Like. The Thread Nipper has the u-shaped housing with two blades that crossover. The purpose of the Thread Nipper is thread-cutting.

U.S. Pat. No. D613,571 S to Quante, is a Cutting Implement. The Cutting Implement has the u-shaped housing with two crossover blades.

U.S. Pat. No. 5,016,353 to Iten, is a Suture Cutter. The Suture Cutter has the u-shaped housing with a blade that functions as a probe. It provides a suture cutter for cutting sutures in a skin surface.

U.S. Pat. No. 4,053,979 to Tuthill and Freeborn, is a Suture Cutter. The Suture Cutter has the u-shaped housing and removes surgical sutures with a slicing action.

U.S. Pat. No. 5,711,075 to Wolf, is a Unitarily Formed Plastic Soft Tissue Nipper. The Soft Tissue Nipper has the u-shaped housing with two blades at the end of each arm. The blades are required to be urged into abutting edge-to-edge contact. The purpose of the Soft Tissue Nipper is to be a hand-held tool for removing soft tissue, such as cuticles at base of finger nails.

U.S. Pat. No. 7,730,620 B1 to Anastasi, is a Plastic Package Opener. The Package Opener has the u-shaped housing with a blade member is mounted within the interior surface of an angled leg in order for the blade member to be directed across the surface of a plastic package.

### SUMMARY

The description of prior art all have the u-shaped housing, however serve the purpose of something other than Plant Pruning.

### SUMMARY OF INVENTION

The present invention, The Original Single Blade Plant Pruner, does not require using a scissor type cutter with two blades to prune plants. The embodiment of the invention is a single blade mounted into the u-shaped housing that presses firmly against a flat surface. Only one blade is used, in order to remove the limb of a plant without damage. Plant pruning with the present invention is not hard on the plant and allows new nodes to reproduce immediately. The present invention prunes without the crushing of the plant limbs. The present invention allows the blade to remain sanitized which allows for a clean, precise cut. The present invention allows for yon to make multiple cuts with the same precision as the first in the circumstance you made your first cut incorrectly. The present invention has an easy squeeze function which allows for easy) safe use in either hand. It allows even the novice pruner ease of use.

Plant pruning is important in everyone's every day life. Plant pruning is a huge industry. Having plants remain undamaged during the pruning phase is a huge breakthrough that will benefit the entire world. Plant pruning is important to the world because: almost all fruits and vegetables that are consumed around the world comes from a plant that has been pruned. Almost all plants, flowers and trees must be pruned to achieve high levels of produce. Being able to prune a plant without damaging the plant limb allows the plant to reproduce quickly.

### DRAWINGS-FIGURES

FIG. 1 shows the present invention side view and over-head view.

FIG. 2 shows the mounted blade

### DRAWINGS-REFERENCE NUMERALS

3. Single Blade

4. U-Shaped Housing

5. Blade Mounting Block

6. Spacer-Flat Surface

7. Blade Slide Cover

8. Slider Nub

9. Blade Mount

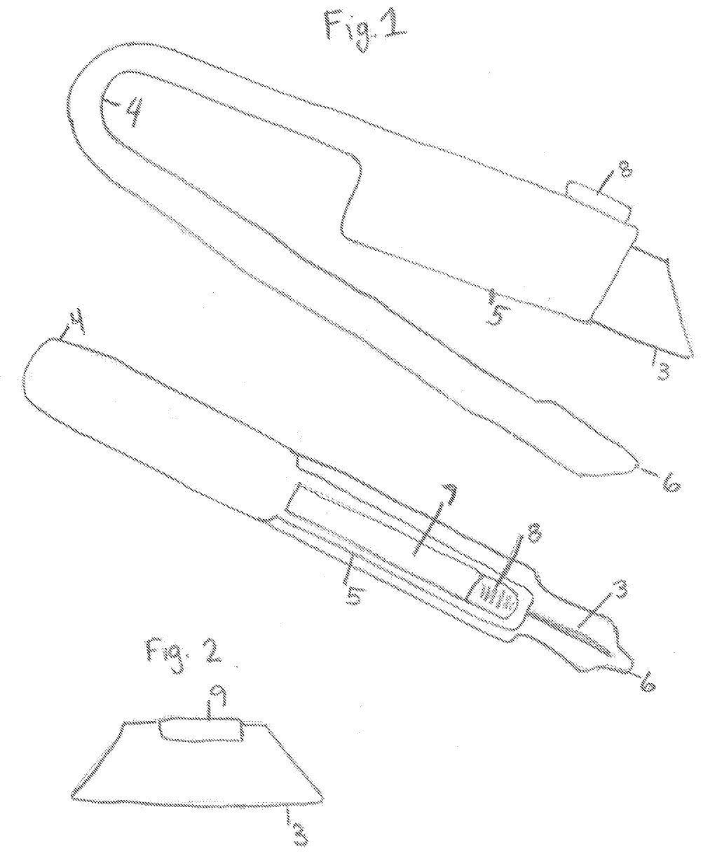

### DETAILED DESCRlPTION-FIG. 1 AND FIG. 2-FIRST EMBODMENT

In the present invention 4, 5, 6 are all one piece. A Single Blade, 3, is used because a plant pruning needs to have one clean, precise cut. The Single Blade, 3, is positioned from front to back, to provide the best angle to cut. It is important to only have one blade as having more than one blade to prune a plant, damages the limbs of the plant. The embodiment of the present invention is the U-Shaped Housing, 4, was made for easy cleaning of the tool, having bacteria get onto to surface of the tool would contaminate the plant. The U-Shaped Housing, 4, is also used for ease of squeezing the tool with one free hand. The Blade Mounting Block. 5, is used to angle 4, the U-Shaped Housing, to the angle, 3, the Single Blade closes on 6, the Spacer-Flat Surface. The Spacer-Flat Surface, 6, doses at the same angle of the Single Blade, 3. The Blade Slide Cover, 7, keeps the Single Blade, 3, securely in place and slides back and forth for easy removal of the Single Blade 3. 8, The Slider Nub is in place to allow easy control of the Blade Slider Cover, 7. The Blade Mount 9, fits on the Single Blade, 3, to secure the Single Blade 3, in the Blade Mounting Block, 5.

### ALTERNATIVE EMBODIMENTS

The present invention can have alternative embodiments. Alternative material can be used for the housing. Alternative material that would work for housing would be: fiberglass, plastic, ABS plastic, PVC Plastic, SCH 40 PVC, SCH 80 PVC Plastic, steel, stainless steel, harden steel, spring steel, aluminum or metal.

Alternative blade angles can be used. Alternative angles would be to insert the blade at a 45-degree angle or straight across. However, the blade will work at these angles the best angle is front to back.

A stop can be mounted in the center, front half of the u-shaped housing to prevent someone from over squeezing the pruner.

I claim:

1. In a plant pruner with a single blade cutting mechanism of the type comprising a u-shaped housing, slider, removeable single blade, and a flat cutting surface for the single blade to cut against.

2. The plant pruner with a single blade cutting mechanism of claim 1 wherein said body is composed of mold injected plastic.

3. The plant pruner with a single blade cutting mechanism of claim 1 wherein said body is a u-shaped housing.

4. The u-shaped housing of claim 3 wherein the top part of the u-shaped housing there is a square dado grove for the single blade to fit into.

5. The u-shaped housing of claim 3 wherein said body has a raised, flat cutting surface beneath the blade.

6. The flat cutting surface of claim 5 wherein said body is raised, the length extends the whole length of the blade and the width of the housing.

7. The plant pruner with a single blade cutting mechanism of claim 1 wherein said body houses a removeable single blade.

8. The single blade of claim 7 wherein said body is a blade with an injection mold encasing the top of the blade.

9. The injection mold of claim 8 wherein the injection mold has a raised notch on one end for the slider to keep blade securely in position.

10. The slider of claim 1 wherein said body is composed of injection mold.

11. The injection mold of claim 10 wherein the body of the slider has a raised button on top of the slider.

12. The slider of claim 10 wherein slides inside a grove in the u-shaped housing directly above the blade.

13. The slider of claim 10 wherein said body has a round indentation underneath the slider which aligns with the notch on the injection mold of the single blade of claim 9.

14. Method of using a plant pruner with single blade cutting mechanism:

15. providing a plant pruner,

16. providing a single blade and inserting the single blade into the plant pruner,

17. pushing closed the slider so the single blade is securely in place,

18. insert plant limb into plant pruner

19. squeeze u-shaped housing closed, bringing the single blade down firmly against the flat cutting surface.
